(19) United States
(12) Patent Application Publication
(10) Pub. No.: US 2007/0223179 A1
(43) Pub. Date: Sep. 27, 2007

(54) FINGERPRINT RECOGNITION SMART CARD

(76) Inventors: Shi Ming Cheng, Pingzhen City (TW); Nai-Ping Chen, Linkou Shiang (TW)

Correspondence Address: PAI PATENT & TRADEMARK LAW FIRM, 1001 FOURTH AVENUE, SUITE 3200, SEATTLE, WA, 98154, US

(21) Appl. No.: 11/308,732

(22) Filed: Apr. 26, 2006

(30) Foreign Application Priority Data
Mar. 27, 2006 (TW) 95205062

(51) Int. Cl. H02B 1/00

(52) U.S. Cl. 361/600

(57) ABSTRACT

A fingerprint recognition smart card includes an electronic card and a fingerprint recognizer. The electric card is insertable into a card slot of an electronic device and comprises a circuit board with an electric connector for electric connection with the electronic device into which the electronic card is inserted, and a receiving open chamber at one side opposite to the electric connector. The fingerprint recognizer, is electrically connected to the circuit board of the electronic card through a flexible bus line and movable in and out of the receiving open chamber between an extended position for use and a received position when not in use.

### BACKGROUND OF THE INVENTION

1. Field of the Invention

The present invention relates to a smart card and more particularly to a fingerprint recognition smart card for use in a mobile electronic device for fingerprint recognition.

2. Description of the Related Art

Various fingerprint recognition systems are known and intensively used in thumb disks and mobile memory sticks. Because these products are exposed to the outside when installed in an electronic device, they may be hit accidentally, causing damage to the internal fingerprint recognition system. Further, the fingerprint recognition system of an electronic product occupies much installation space in the product and can only protect the privacy of the product.

There are mobile electronic devices such as notebook computers, PDAs, or cell phones that have a fingerprint recognizer directly installed therein. However, a mobile electronic device with fingerprint recognizer commonly has a complicated structure and a high manufacturing cost. Further, when the fingerprint recognizer failed, the mobile electronic device cannot be used. In this case, the user may have to send the mobile electronic device back to the distributor for examination and repair, or to buy a new mobile electronic device. It is neither convenient nor economic to use this kind of mobile electronic device.

### SUMMARY OF THE INVENTION

The present invention has been accomplished under the circumstances in view. It is the main object of the present invention to provide a fingerprint recognition smart card which can be connected to an electronic device conveniently and conveniently set in the position of use for enabling the electronic device to recognize the user's fingerprint.

To achieve this and other objects of the present invention, the fingerprint recognition smart card comprises an electronic card and a fingerprint recognizer. The electronic card comprises a housing, a circuit board mounted inside the housing, and an electric connector mounted in one side of the housing and electrically connected to the circuit board for insertion with the housing into a card slot of an electronic device for communication with the electronic device. The housing has a receiving open chamber at one side thereof opposite to the electric connector. The fingerprint recognizer is electrically connected to the circuit board of the electronic card. Further, the fingerprint recognizer is movable in and out of the receiving open chamber between an extended position for use and a received position when not in use.

### BRIEF DESCRIPTION OF THE DRAWINGS

FIG. 1 is an exploded view of a fingerprint recognition smart card according to the present invention.

FIG. 2 is a schematic drawing showing the fingerprint recognizer moved out of the receiving open chamber of the electronic card for use.

FIG. 3 is a schematic drawing showing the fingerprint recognizer received in the receiving open chamber of the electronic card.

### DETAILED DESCRIPTION OF THE INVENTION

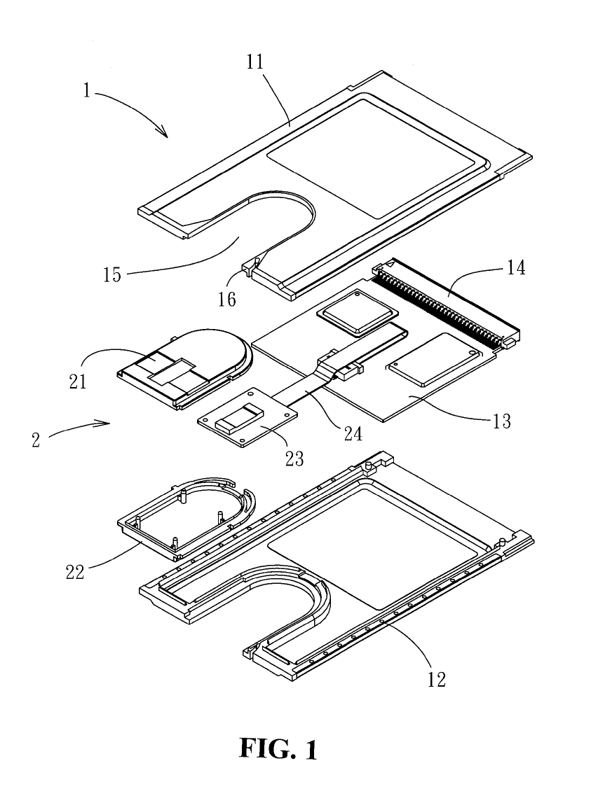

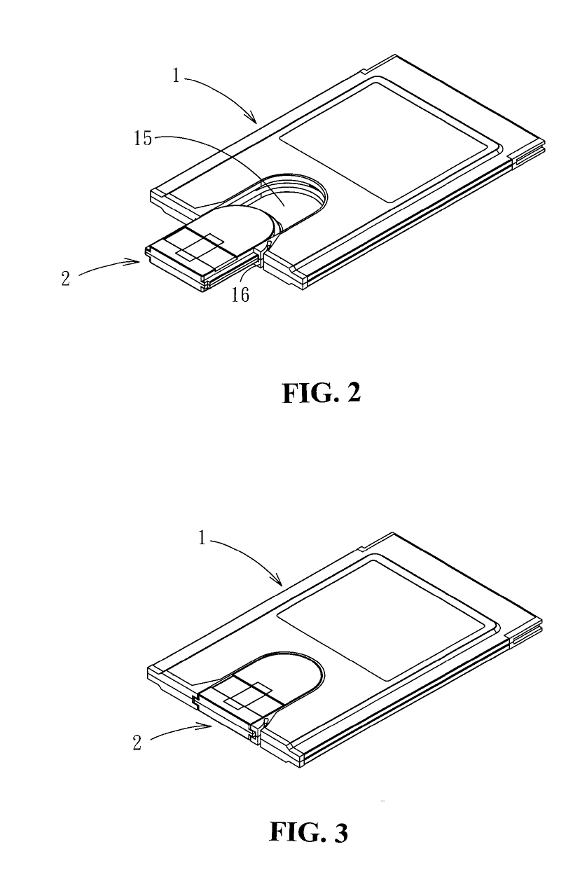

Referring to FIGS. 1˜3, a fingerprint recognition smart card in accordance with the present invention comprises an electronic card 1 and a fingerprint recognizer 2. The fingerprint recognition smart card is insertable into an insertion slot of an electronic device (such as notebook computer or PDA, not shown). According to the present preferred embodiment, the fingerprint recognition smart card is in compliance with the PCMCIA protocol. Alternatively, the fingerprint recognition smart card can be made subject to any of a variety of other protocols.

The electronic card 1 comprises a housing, which is formed of a top cover shell 11 and a bottom cover shell 12, a circuit board 13 mounted inside the housing, and an electric connector 14 mounted in one side of the housing and electrically connected to the circuit board 13. The electric connector 14 is made in compliance with the PCMCIA protocol. The housing has a receiving open chamber 15 at one side remote from the electric connector 14 for accommodating the fingerprint recognizer 2 and a retaining member 16 disposed at one side in the receiving open chamber 15 for securing the fingerprint recognizer 2.

The fingerprint recognizer 2 is electrically connected to the circuit board 13 and detachably mounted in the receiving opening 15. According to the present preferred embodiment, the fingerprint recognizer 2 comprises a top cover shell 21, a bottom cover shell 22 fitting the top cover shell 21, and a fingerprint recognition circuit module 23 positioned in between the top cover shell 21 and the bottom cover shell 22 and electrically connected to the circuit board 13 with a flexible bus line 24.

Upon insertion of the electronic card 1 into a PCMCIA slot of an electronic device (not shown), the electric connector 14 is electrically connected to the electronic device. When in use, the fingerprint recognizer 2 can be disengaged from the retaining member 16 and moved out of the receiving open chamber 15 along so that the fingerprint recognizer 2 can scan the user's fingerprint conveniently. By means of the springy property of the plastic material of the retaining member 16 and the top and bottom cover shells 21 and 22 of the fingerprint recognizer 2, the fingerprint recognizer 2 automatically springs outwards from the receiving open chamber 15 when the fingerprint recognizer 2 is pushed forward and disengaged from the retaining member 16. When not in use, the fingerprint recognizer 2 is pushed back to the inside of the receiving opening 15 and secured in place by the retaining member 16.

The mechanical action of the present invention fully utilizes the springy property of plastic material property and principle of dynamics so that no supplementary device is necessary to move the fingerprint recognizer 2. Therefore, the design of the present invention saves much material cost and manufacturing time and labor. In consideration of cost and the way and frequency of use, the aforesaid semi-automatic fingerprint recognizer ejection design is the best. Further, when the fingerprint recognition smart card fails, it can be separately delivered to the distributor for examination and repair. Further, the fingerprint recognition smart card has built-in software for ready use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fingerprint recognition smart card comprising:
an electronic card, said electronic card comprising a housing, a circuit board mounted inside said housing, and an electric connector mounted in one side of said housing and electrically connected to said circuit board for insertion with said housing into a card slot of an electronic device for communication with said electronic device, said housing having a receiving open chamber at one side thereof opposite to said electric connector; and
a fingerprint recognizer electrically connected to said circuit board of said electronic card and movable in and out of said receiving open chamber.

2. The fingerprint recognition smart card as claimed in claim 1, wherein said housing comprises a top cover shell and a bottom cover shell abutted against said top cover.

3. The fingerprint recognition smart card as claimed in claim 1, wherein said fingerprint recognizer comprises a top cover shell, a bottom cover shell abutted against the top cover shell of said fingerprint recognizer, and a fingerprint recognition circuit module mounted in between the top cover shell and the bottom cover shell of said fingerprint recognizer.

4. The fingerprint recognition smart card as claimed in claim 3, wherein said fingerprint recognition circuit module has a flexible bus line electrically connected to said electric connector of said electronic card.

5. The fingerprint recognition smart card as claimed in claim 1, wherein said housing has a retaining member disposed in said receiving open chamber at one side and adapted to secure said fingerprint recognizer.
